(19) United States
(12) Patent Application Publication
(10) Pub. No.: US 2009/0262143 A1
(43) Pub. Date: Oct. 22, 2009

(54) METHOD FOR DISPLAYING INFORMATION, AND ELECTRONIC APPARATUS AND STORAGE MEDIUM THEREOF

(75) Inventors: Yone-Myint Kyu, Taoyuan County (TW); Tsu-Chin Wu, Taoyuan County (TW); Chih-Wei Yang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/187,386

(22) Filed: Aug. 7, 2008

(30) Foreign Application Priority Data
Apr. 18, 2008 (TW) 97114574

(51) Int. Cl. G09G 5/00; G09G 5/32

(52) U.S. Cl. 345/661; 345/660; 345/581

(57) ABSTRACT

A method for displaying information is provided. A display area is provided for displaying at least a portion of an information page, wherein the information page includes at least an information column, and the information column is composed of a plurality of information units arranged along an arrangement direction. When a select event occurs in the information column, the information units in the information column are displayed according to a display size within a predetermined size range. Next, the layout of the information units in the information column is changed so that an arrangement length of the information units along the arrangement direction does not exceed the width of the display area.

### CROSS-REFERENCE TO RELATED APPLICATION

This application claims the priority benefit of Taiwan application serial no. 97114574, filed on Apr. 18, 2008. The entirety of the above-mentioned patent application is hereby incorporated by reference herein and made a part of specification.

### BACKGROUND OF THE INVENTION

1. Field of the Invention

The present invention generally relates to an information displaying technique, and more particularly, to an information displaying technique adaptable to an electronic apparatus.

2. Description of Related Art

FIG. 1 is a diagram illustrating how a portable electronic apparatus displays an information page. Referring to FIG. 1, when a user views an information page, such as a webpage, by using a portable electronic apparatus, the image shown in the display area 102 is displayed. Generally, an information page may contain a plurality of information columns 104 which are respectively composed of words and a plurality of information columns 108 which are respectively composed of pictures. However, because of the limited screen size of the portable electronic apparatus, only a portion of the information page can be displayed in the display area 102. If the user wants to look at the other portions of the information page, he/she has to move the display area 102 by using the scroll bars 122 and 124.

As described above, due to the limitation in the screen size of the electronic apparatus, if all the information in an information page is displayed in the display area 102, the information (regardless of whether it is text information or pictures) will become unrecognizable because of the small displayed size. Thus, conventionally, a technique which allows a user to directly perform predetermined operations through certain input devices (for example, a touch panel) in the display area 102 is developed. For example, the user directly clicks the information column 104 as shown in FIG. 1 to change the image into the image as shown in FIG. 2. As shown in FIG. 2, the width of the information column 104 is substantially the same as the width of the display area 102 but does not exceed it.

Accordingly, the information displayed in the display area 102 is focused on the content of the information column 104, and the user can read the information (for example, text) in the information column 104 conveniently. However, the technique described above only adjusts the zoom ratio of the information page in the display area but cannot make sure that the information in the information column 104 is displayed with an appropriate display size (for example, the size of the characters). In other words, through this technique, the user may not be able to read a specific portion of the information page he/she has selected conveniently through the predetermined operation.

### SUMMARY OF THE INVENTION

Accordingly, the present invention is directed to a method for displaying an information page which allows a user to conveniently read information provided by the information page.

The present invention is directed to an electronic apparatus which can be served as a platform for displaying information.

The present invention provides an information page displaying method. The method displays a portion of an information page in a display area, wherein the information page includes at least an information column, and the information column is composed of a plurality of information units arranged along an arrangement direction. When a select event occurs in the information column, the information units in the information column are displayed according to a display size within a predetermined size range. Then, the layout of the information units in the information column is changed so that an arrangement length of the information units in the arrangement direction does not exceed the width of the display area. Accordingly, a user can view all the information in the information column by simply moving the display area along a browsing direction, wherein the browsing direction is substantially perpendicular to the arrangement direction.

The present invention provides an information page displaying system suitable for an electronic apparatus. The system includes a loading module, a detecting module, and an adjusting module. The loading module loads an information page, wherein the information page has at least an information column, and the information column is composed of a plurality of information units arranged along an arrangement direction. The detecting module detects whether or not a select event occurs in the information column and issues a switch command to the adjusting module when the select event occurs. When the adjusting module receives the switch command, the adjusting module displays the information units in the information column according to a display size within a predetermined size range. Next, the layout of the information units in the information column is changed so that an arrangement length of the information units in the arrangement direction does not exceed the width of the display area. Thereby, a user can view all the information in the information column by simply moving the display area along a browsing direction, wherein the browsing direction is substantially perpendicular to the arrangement direction.

The present invention also provides a storage medium which stores a plurality of command codes, wherein the command codes are used for driving an electronic apparatus to display an information page. The information page has at least an information column, and the information column is composed of a plurality of information units arranged along an arrangement direction. When a select event occurs in the information column, the information units in the information column are displayed according to a display size within a predetermined size range. Next, the layout of the information units in the information column is changed so that an arrangement length of the information units in the arrangement direction does not exceed the width of the display area. Thereby, a user can view all the information in the information column by simply moving the display area along a browsing direction, wherein the browsing direction is substantially perpendicular to the arrangement direction.

According to an embodiment of the present invention, the step for detecting whether or not the select event occurs in the information column includes detecting whether or not the information column is continuously clicked twice.

In the present invention, the information units (for example, words, pictures, or icons) in an information column are displayed according to a display size within a predetermined size range when a select event occurs in the information column, wherein the display size (for example, the display size of characters or pictures) within the predetermined size range is always an appropriate display size which allows a user to view the information in the information column conveniently. The predetermined size range may be set manually or obtained by recording and calculating a historical data about the display behaviours of the display area, such as the display size of the display area which is mostly used for displaying the information units. Thereby, a user can conveniently view information in an electronic apparatus, especially a handheld apparatus having a small-sized screen, through the technique provided by the present invention. Moreover, according to the present invention, the layout of the information units in the information column can be changed after the displayed sizes of the information units in the information column are changed, so that the user can view all the information in the information column by simply moving the display area along a browsing direction. Thereby, it is made more convenient for the user to view the information in the information page.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating how a portable electronic apparatus displays an information page.

FIG. 2 is a diagram illustrating how a portable electronic apparatus displays a zoomed information page.

FIG. 3 is a diagram of an electronic apparatus.

FIG. 4 illustrates a circuit structure of an electronic apparatus according to an embodiment of the present invention.

FIG. 5 is a diagram of a display system according to an embodiment of the present invention.

FIG. 6 is a flowchart of a method for displaying an information page according to an embodiment of the present invention.

FIG. 7 is a diagram illustrating how a portion of an information page is displayed according to an embodiment of the present invention.

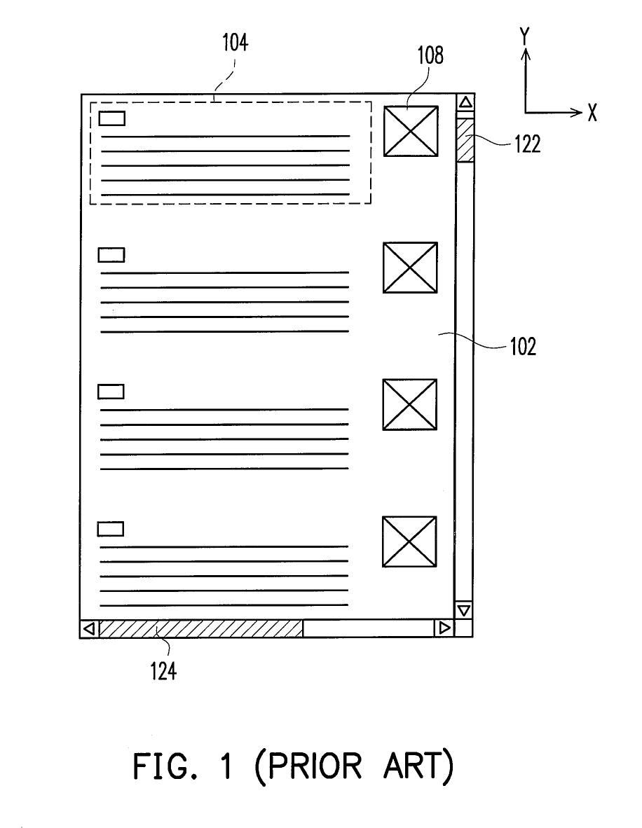

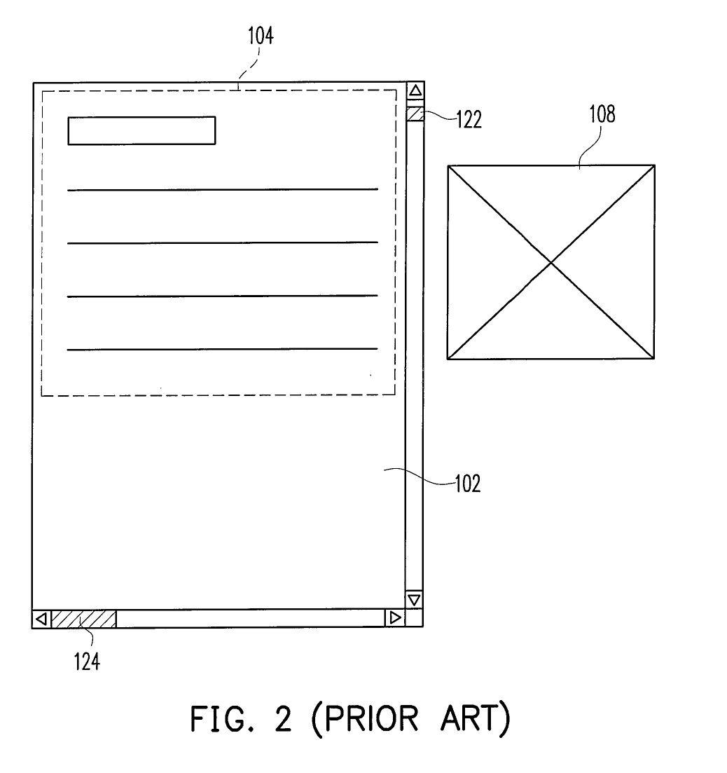

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

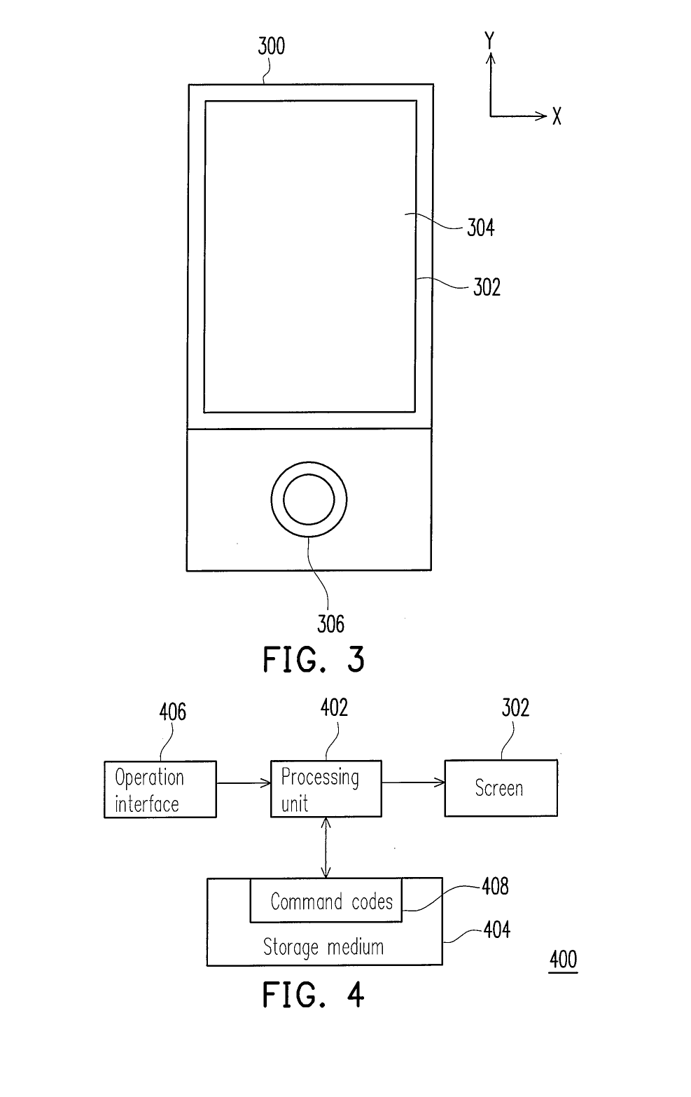

FIG. 3 is a diagram of an electronic apparatus. Referring to FIG. 3, in the present embodiment, the electronic apparatus 300 may be a mobile phone, a personal digital assistant (PDA), a pocket PC, or a global positioning system (GPS) receiver, etc. The electronic apparatus 300 includes a screen 302, such as a touch panel, which has a display area 304. The display area 304 has its own margins and width in respectively direction X and direction Y. In the present embodiment, the direction X is substantially perpendicular to the direction Y. In addition, besides the touch panel 302, the operation interface of the electronic apparatus 300 may further include the button or push-button switch 306 as shown in FIG. 3. A user can control the operation of the electronic apparatus 300 by using different types of operation interfaces.

FIG. 4 illustrates a circuit structure 400 of an electronic apparatus according to an embodiment of the present invention, wherein the circuit structure 400 may be implemented in the electronic apparatus 300 as shown in FIG. 3. Referring to FIG. 4, the circuit structure 400 includes a processing unit 402, a storage medium 404, an operation interface 406, and aforementioned screen 302. The processing unit 402 is coupled to the screen 302, the operation interface 406, and the storage medium 404 through a transmission interface. The storage medium 404 may be a non-volatile memory, such as a read only memory (ROM), a flash memory, a hard disc device, or a compact disc (CD) medium.

The storage medium 404 stores a plurality of command codes 408. The command codes 408 drive the processing unit 402 to process an information page and display the information page in the screen 302, wherein the method for processing and displaying the information page will be described below. In other words, the processing unit 402 driven by the command codes 408 can execute a method provided in an embodiment of the present invention. In addition, the operation interface 406 may be the aforementioned touch panel or a signal input device such as a push-button switch.

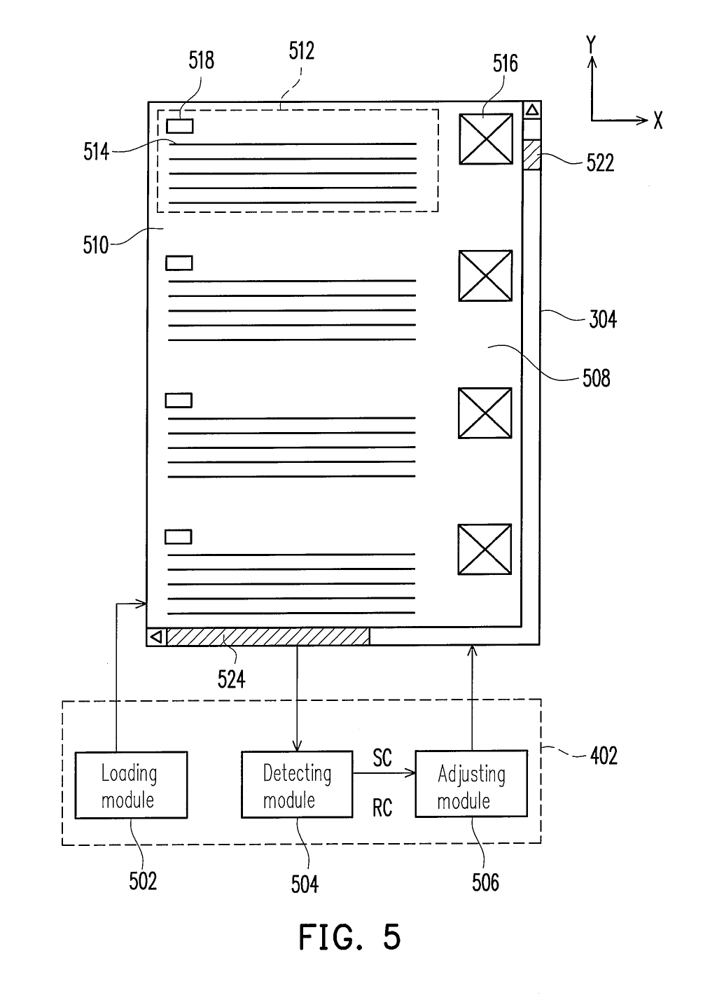

FIG. 5 is a diagram of a display system according to an embodiment of the present invention, wherein the display system is generated when the processing unit 402 in FIG. 4 executes the command codes 408. Referring to FIG. 5, in the present embodiment, the display system includes a loading module 502, a detecting module 504, and an adjusting module 506. The loading module 502 loads an information page 510 and displays the information page 510 in the display area 304, wherein the display area 304 may be located in the screen 302 as shown in FIG. 4. In the present embodiment, the loading module 502 can obtain the information page 510 from the Internet or directly from the storage medium 404.

The information page 510 contains at least an information column 512, and the information column 512 is composed of a plurality of information units 514 arranged along an arrangement direction (for example, along the direction X in the present embodiment). In the present embodiment, the information units 514 in the information column 512 are words, and in another embodiment of the present invention, the information units 514 in the information column 512 may also be pictures or icons, such as the information units in the information column 516.

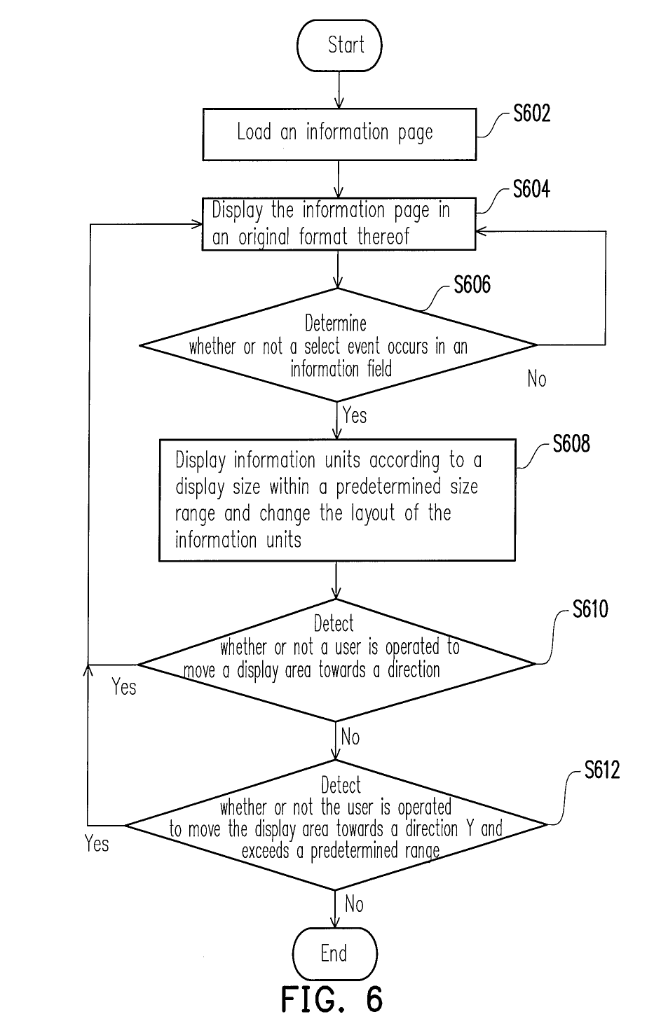

FIG. 6 is a flowchart of a method for displaying an information page according to an embodiment of the present invention. Referring to both FIG. 5 and FIG. 6, in step S602, the loading module 502 loads the information page 510. Then, in step S604, the information page 510 is displayed in the display area 304 in an original format of the information page 510. Herein if the original size of the information page 510 exceeds the range of the display area 304, only a portion of the information page 510 can be displayed in the display area 304. In this case, the user has to move the display area 304 by using the scroll bars 522 and 524 to view the other portions of the information page 510. Besides, when the information page 510 is displayed in its original size, the information units 514 (text, pictures, or icons) may be very small and difficult to read.

In order to describe the present invention more conveniently and to allow those having ordinary knowledge in the art to understand the spirit of the present invention more clearly, the information units 514 will be described as texts in following descriptions.

Referring to FIG. 5 and FIG. 6 again, in step S606, the detecting module 504 determines whether or not a select event occurs in the information column 512. The select event may be triggered by the user through the operation interface 406 as shown in FIG. 4, such as the touch panel 508 in FIG. 5. Thus, in the present embodiment, the step for determining whether or not the select event occurs in the information column 512 may be determining whether or not the user clicks the touch panel 508 for a predetermined times (for example, twice) in the information column 512. If it is determined that the user clicks the touch panel 508 twice, it is determined that the select event occurs in the information column 512.

When the detecting module 504 detects that the select event occurs in the information column 512, the detecting module 504 generates a switch command SC to the adjusting module 506. Then, in step S608, the adjusting module 506 displays the information units 514 in the information column 512 according to a display size (for example, displays each of the information units 514 in the information column 512 with 15×15 pixels), wherein the display size is within a predetermined size range (for example, 10×10 pixels˜20×20 pixels). The information units displayed according to display sizes within the predetermined size range can be read by the user instantly and conveniently. Thus, this predetermined size range can be set manually or obtained by recording and calculating a historical data regarding the display behaviours of the display area. For example, the predetermined size range contains display sizes of the display area which are mostly used for displaying the information units.

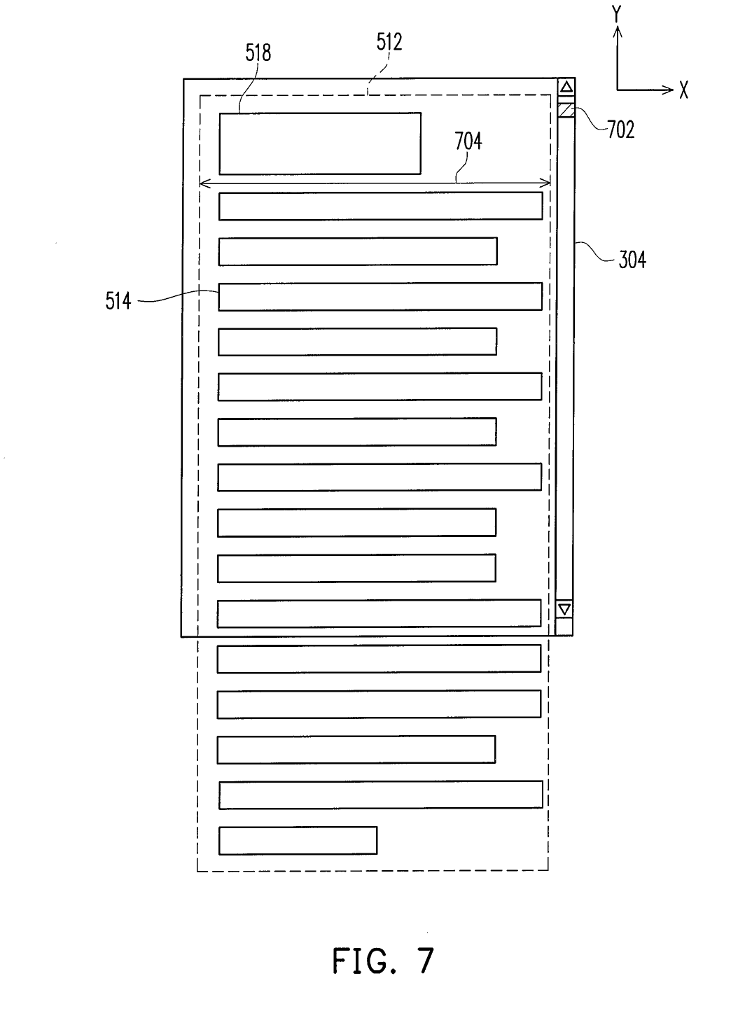

The difference in the display of the information column 512 before or after the step S608 can be understood by comparing FIG. 5 and FIG. 7. In FIG. 5, the display size of the information units 514 is only 5×5 pixels, which may be too small to the user. Thus, through the adjustment of the adjusting module 506, the display size thereof is changed to 15×15 pixels in FIG. 7 so that the user can read the information conveniently. However, the size of the information column 512 changes along with the display size of the information units 514 and accordingly the width of the information column 512 exceeds the width of the display area 304, which makes it very inconvenient to the user. Thus, in step S608, the layout of the information units 514 is also changed to change the width of the information column 512. The rule for changing the layout of the information units 514 is to make the width of the information column 512 to approximate the width of the display area 304 but not exceed it. Namely, an arrangement length 704 of the information units 514 in the arrangement direction (for example, the direction X in the present embodiment) approximates but does not exceed the width of the display area 304. Accordingly, the length of the information column 512 may exceed the length of the display area 304, but the width thereof does not exceed the width of the display area 304. In this case, the user can browse all the information in the information column 512 by simply moving the display area 304 along a browsing direction (for example, the direction Y in the present embodiment) through the scroll bar 702. In the present embodiment, the browsing direction and the arrangement direction are perpendicular to each other.

In addition, referring to FIG. 5, before the step S608 is executed, the information column 512 may have information units 514 displayed in different display sizes (for example, the information units 514 are displayed with 5×5 pixels while the information unit 518 is displayed with 8×8 pixels). Thus, an additional function is provided in step S608, which is to make the information unit 518 in FIG. 7 also greater than the information units 514 or even maintains a specific ratio between the display sizes of the information units 514 and the information unit 518. Namely, the ratio between the display sizes of the information units 514 and the information unit 518 before the step S608 is executed is equal to the ratio between the display sizes of the information units 514 and the information unit 518 after the step S608 is executed (for example, in FIG. 7, the information units 514 are displayed with 10×10 pixels and the information unit 518 is displayed with 16×16 pixels).

Additionally, in the present embodiment, a recover mechanism is further provided after the user finishes reading the information in the information page 510 by using the layout illustrated in FIG. 7 so that the user can return to the mode before the select event occurs to read the information page 510. Referring to FIGS. 5, 6, and 7, because in the present embodiment, the user can browse all the information in the information column 512 by simply moving the display area 304 along the direction Y (the browsing direction) in the mode illustrated in FIG. 7, when the detecting module 504 detects that the user performs an operation to move the display area 304 towards the direction X (the arrangement direction) in step S610, it is determined that the user wants to go back to the display mode illustrated in FIG. 5. In this case, the detecting module 504 issues a recover command RC to the adjusting module 506 so that the adjusting module 506 displays the information page 510 in the original format of the information page 510 before the select event occurs. Accordingly, the user can read the information page 510 in the mode as shown in FIG. 5.

Besides performing the recover operation by using the method described in foregoing step S610, the detecting module 504 may also perform the recover operation as in step S612. In step S612, whether or not the user operates to move the display area 304 towards the direction Y (the browsing direction) and exceeds a predetermined range (for example, the range of the information column 512) is determined. When the detecting module 504 determines that the user moves the display area 304 towards the direction Y and exceeds the predetermined range (“Yes” in step S612), then in the present embodiment it is determined that the user wants to read information out of the information column 512. In this case, the detecting module 504 also issues the recover command RC to the adjusting module 506. Similarly, when the adjusting module 506 receives the recover command RC, it displays the information page 510 according to the original format of the information page 510 before the select event occurs so that the user can read the information page 510 in the mode illustrated in FIG. 5.

In overview, according to the present invention, when a select event occurs in an information column, the information units in the information column are displayed according to a display size within a predetermined size range, and the layout of the information units is changed so that the width of the information column won't exceed the width of the display area. Thereby, a user can read the information in the information column more clearly and conveniently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying an information page, comprises:
displaying at least a portion of the information page in a display area, wherein the information page comprises at least an information column having a plurality of information units arranged along an arrangement direction;
displaying the information units according to a display size within a predetermined size range when a select event occurs in the information column; and
changing a layout of the information unit in the information column so that an arrangement length of the information units in the arrangement direction does not exceed a width of the display area.

2. The method according to claim 1, further comprises:
detecting whether or not the display area of the information column is operated to move towards the arrangement direction after the select event occurs; and
displaying the information page in the display area according to an original format before the select event occurs when the display area is operated to move towards the arrangement direction.

3. The method according to claim 1, further comprising:
detecting whether or not the display area is operated to move towards a browsing direction and exceeds a predetermined range after the select event occurs; and
displaying the information page in the display area according to an original format before the select event occurs when the display area is operated to move towards the browsing direction and exceeds the predetermined range.

4. The method according to claim 3, wherein the browsing direction is substantially perpendicular to the arrangement direction.

5. The method according to claim 1, wherein the information units comprise at least one of words, pictures, and icons.

6. The method according to claim 1, wherein the predetermined size range is obtained by setting or calculating a historical data regarding display behaviours of the display area.

7. The method according to claim 6, wherein the historical data comprises the display size of the display area mostly used for displaying the information units.

8. The method according to claim 1, wherein ratios of displayed sizes between different information units among the information units remain the same before or after the select event occurs.

9. The method according to claim 1, wherein the step for detecting whether the select event occurs comprises detecting whether or not the information column is continuously clicked for a predetermined times.

10. A system for displaying an information page is suitable for an electronic apparatus, comprising:
a loading module, for loading and displaying the information page in a display area of the electronic apparatus, wherein the information page comprises at least an information column having a plurality of information unit arranged along an arrangement direction;
a detecting module, for detecting whether or not a select event occurs in the information column, and issuing a switch command when the select event occurs; and
an adjusting module, coupled to the detecting module, for displaying the information units according to a display size within a predetermined size range when the switch command is issued and changing a layout of the information units in the information column so that an arrangement length of the information units in the arrangement direction does not exceed a width of the display area.

11. The system according to claim 10, wherein the detecting module further detects whether or not the display area is operated to move towards the arrangement direction after the select event occurs and issues a recover command to the adjusting module when the display area is operated to move towards the arrangement direction to display the information page in the display area according to an original format before the select event occurs.

12. The system according to claim 10, wherein the detecting module further detects whether or not the display area is operated to move towards a browsing direction and exceeds a predetermined range after the select event occurs, and the detecting module further issues a recover command to the adjusting module to display the information page in the display area according to an original format before the select event occurs when the display area is operated to move towards the browsing direction and exceeds the predetermined range.

13. The system according to claim 12, wherein the browsing direction is substantially perpendicular to the arrangement direction.

14. The system according to claim 10, wherein the information units comprise at least one of words, pictures, and icons.

15. The system according to claim 10, wherein the predetermined size range is obtained by setting or calculating a historical data regarding display behaviours of the display area.

16. The system according to claim 15, wherein the historical data comprises the display size of the display area mostly used for displaying the information units.

17. The system according to claim 10, wherein ratios of displayed sizes between different information units among the information units remain the same before or after the select event occurs.

18. The system according to claim 10, wherein the detecting module detects whether the select event occurs by detecting whether or not the information column is continuously clicked for a predetermined times.

19. The system according to claim 10, wherein the electronic apparatus is one of a mobile phone, a personal digital assistant (PDA), and a pocket PC.

20. A storage medium, for storing a plurality of command codes, wherein the command codes are used for driving an electronic apparatus to execute a display method, and the display method comprises:
displaying at least a portion of an information page in a display area of the electronic apparatus, wherein the information page comprises at least an information column having a plurality of information units arranged along an arrangement direction;
displaying the information units according to a display size within a predetermined size range when a select event occurs in the information column; and
changing a layout of the information units in the information column so that an arrangement length of the information units in the arrangement direction does not exceed a width of the display area.
